(19) United States
(12) Patent Application Publication
(10) Pub. No.: US 2008/0056955 A1
(43) Pub. Date: Mar. 6, 2008

(54) ULTRA-TRACE SAMPLE CONCENTRATOR AND METHODS OF USE

(76) Inventors: Waleed M. Maswadeh, Rosedale, MD (US); Dawlah M.H. Abu Dwaih, Amman (JO)

Correspondence Address: Gibb & Rahman, LLC, 2568-A RIVA ROAD SUITE 304, ANNAPOLIS, MD, 21401, US

(21) Appl. No.: 11/468,841

(22) Filed: Aug. 31, 2006

(51) Int. Cl. B01L 11/00

(52) U.S. Cl. 422/101

(57) ABSTRACT

A trap sample concentrator and method of use comprises a pair of opposed ends each having an opening; a trap region in between the pair of opposed ends and having a longitudinal axis; a pair of side portions comprising a plurality of ports that are adapted to facilitate a flow of materials therethrough in a direction that is substantially perpendicular to the longitudinal axis; a plurality of ports in the pair of side portions; and a plurality of stops adapted to open and close the plurality of ports in the pair of side portions and the openings of the pair of opposed ends. The trap region is adapted to house at least one type of adsorbent material, wherein trace analytes become trapped upon the introduction of a loading buffer in the trap region.

### BACKGROUND

1. Technical Field

The embodiments herein generally relate to specimen sample analysis as well as purification processes, and, more particularly, to sample traps and concentrators used to isolate trace biochemicals and chemical specimens for analysis.

2. Description of the Related Art

Trap ultra-trace sample concentrators were developed to significantly reduce the overall time of loading and desorbing of ultra-trace analytes from large volume(s) as well as to improve the sensitivity of the analysis of analytes of interest in gas or liquid samples. Standard and commercially available trap sample concentrators were first developed when packed columns were used in most gas chromatographs and liquid chromatography. More recent trap sample concentrators generally consist of a short tube with a narrow inside diameter, which is packed with adsorbing material. The complete operating cycle of a standard trap generally consists of loading, washing/rinsing/drying, and an eluting process. The conventional traps are typically made of a tube with absorbing material packed inside with the loading and elution ports (inlet and outlet) being the same. Generally, the most dominant and slowest process is the loading process to attain the desired elution concentration.

The analysis of volatile organic compounds (VOCs, in gas phase) by purge and trap is perhaps the most widely employed method of trace analysis in environmental organic chemistry. This is because it is applicable to a wide variety of analytes in practically any sample matrix and is generally, to date, the preferred choice in method sensitivity. Moreover, the analysis of non-volatile organic compounds and biomolecules are most widely performed by liquid loading to the trap and is perhaps the most widely employed method of trace analysis in environmental, pharmaceutical, medical, and food industry applications.

Conventional protein traps are used to concentrate samples and remove salts, buffers and other small, polar molecules prior to the analysis or characterization of trapped proteins using high performance liquid chromatography (HPLC), liquid chromatography/mass spectrometry (LC/MS), and matrix assisted laser-desorption ionization time-of-flight mass spectrometry (MALDI TOF-MS). Biomolecular (non-volatile organics) traps may be used to concentrate trace bio-samples up to 100 fold yielding excellent recovery of most large biological components (>90% at levels). Non-volatile traps have also shown to separate, purify, quantify, and/or characterize trace level of biological and pharmaceutical samples.

Generally, the two types of traps (gas traps and liquid traps) share two things in common: a loading (absorbing) process of trace analytes from a large volume followed by an elution (desorbing) process of the trapped analytes to concentrated analytes into a small volume. The inside diameter of the trap generally defines the loading and elution flow rates. Accordingly, as the inside diameter of the trap decreases, the concentration of trapped analytes increases. Moreover, reducing the inside diameter of the trap typically reduces the internal volume of the trap (quadratic function). Hence, by reducing the inside diameter of the trap, the loading flow rate also reduces significantly to the power of two (proportional to the cross-sectional area). However, reducing the inside diameter of the trap generally translates into a longer required time to load a fixed large volume of trace sample into the trap. Accordingly, there remains a need for a trap to reduce the overall trapping time or dramatically reduce the time of concentrating trace analytes.

Typically with a conventional trap trace sample concentrator 1, as shown in FIGS. 1 and 2, the sample concentration cycle involves at least two steps: adsorbing and desorbing as described above. During the loading (adsorbing) stage, as shown in FIG. 1, the trace analyte stream flows through the trap 1 (from point A to point B), which is at a desired temperature. The loading stage is the most time consuming stage and there is a great need to reduce the loading time but at the same time keep the elution time and volume at a desired minimum. During the desorbing stage, as shown in FIG. 2, the trap 1 is either heated (gas trap) and flushed with carrier (inert) gas or an elution buffer is introduced (liquid trap) and flushed with an elution fluid. The concentrated analyte stream 3 flows through the trap 1 to an analytical system (not shown in FIGS. 1 and 2).

In standard traps 1, the trace sample 3 is generally exposed and adsorbed mainly by the inlet region 2 of the trap 1 while very little is exposed at the outlet region 4. Conventional traps 1 have adsorption (loading) flow rates very close to the desorption (elution) flow rate (e.g., approximately 1 cc/min). For 1 minute loading, 1 mL of sample is passed through the trap 1 and retained. Generally, the maximum amount of sample 3 that can be eluted out and analyzed by the gas chromatography/mass spectrometry (GC/MS) or LC/MS is equivalent to the amount in the 1 mL of sample loaded and trapped by the trap 1. Accordingly, there remains a need for a trap capable of reducing the overall trapping time or dramatically reduce the time of concentrating trace analytes.

### SUMMARY

In view of the foregoing, an embodiment herein provides a trap sample concentrator comprising a trap region having a longitudinal axis, the trap region comprising a first end having an opening; a second end having an opening, the back end being positioned opposite to the first end; a first side portion that is substantially parallel to the longitudinal axis, the first side portion comprising a plurality of ports; a second side portion that is substantially parallel to the longitudinal axis, the second side portion comprising a plurality of ports; and a channel region positioned in between and bounded by the first end, the second end, the first side portion, and the second side portion. The trap sample concentrator further comprises at least one stop adapted to open and close the plurality of ports and the openings of the first end and the second end. Preferably, the channel region is adapted to house at least one type of adsorbent material, wherein trace analytes become trapped upon the introduction of a loading buffer in the channel region. Furthermore, the trap region may comprise exactly two side portions each positioned on directly opposite sides of the channel region. Also, the plurality of ports located in the first side portion may comprise loading inlet ports, the plurality of ports located in the second side portion may comprise loading outlet ports, the first end may be an eluting inlet port, and the second end may be an eluting outlet port.

Additionally, the at least one stop is preferably adapted to close the first end and the second end while the plurality of ports are open, and the plurality of ports are preferably adapted to close while the first end and the second end are open. Moreover, the trap region may be dimensioned and configured in any of a straight, U-shape, and coil configuration. Furthermore, the plurality of ports is preferably adapted to create a greater flow rate of materials passing through than the flow rate created by the openings in the first end and the second end. Preferably, the plurality of ports are adapted to pass through a trace sample of interest through the channel region during a loading stage of a trap sample process, and the openings in the first end and the second end are preferably adapted to pass through an elution buffer media through the channel region during an eluting stage of the trap sample process. Also, the second end may be adapted to connect to an analytical instrument comprising any of a liquid chromatograph, gas chromatograph, mass spectrometer, ultraviolet/visible light detector, an infrared (IR) detector, and a combination thereof, wherein preferably greater than 80% of all trapped analytes are directly delivered to the analytical instrument.

Another embodiment provides a trap sample concentrator comprising a pair of opposed ends each having an opening; a trap region in between the pair of opposed ends and having a longitudinal axis; a pair of side portions comprising a plurality of ports that are adapted to facilitate a flow of materials therethrough in a direction that is substantially perpendicular to the longitudinal axis; a plurality of ports in the pair of side portions; and a plurality of stops adapted to open and close the plurality of ports in the pair of side portions and the openings of the pair of opposed ends. Preferably, the trap region is adapted to house at least one type of adsorbent material, wherein trace analytes become trapped upon the introduction of a loading buffer in the trap region. Furthermore, the trap region may comprise exactly two side portions each positioned on directly opposite sides of one another. Additionally, the plurality of ports of a first side portion may be loading inlet ports, the plurality of ports of a second side portion may be loading outlet ports, a first end of the pair of opposed ends may be an eluting inlet port, and a second end of the pair of opposed ends may be an eluting outlet port. Moreover, the plurality of stops are preferably adapted to close the pair of opposed ends while the plurality of ports are open, and preferably the plurality of stops are adapted to close the plurality of ports while the pair of opposed ends are open.

The trap region may be dimensioned and configured in any of a straight, U-shape, and coil configuration. Also, the plurality of ports may be adapted to create a greater flow rate of materials passing through than the flow rate created by the openings in pair of opposed ends. Preferably, the plurality of ports are adapted to pass through a trace sample of interest through the trap region during a loading stage of a trap sample process, wherein the openings in the pair of opposed ends are adapted to pass through an elution buffer media through the trap region during an eluting stage of the trap sample process. Furthermore, a second end of the pair of opposed ends is preferably adapted to connect to an analytical instrument comprising any of a liquid chromatograph, gas chromatograph, mass spectrometer, ultraviolet/visible light detector, an IR, and a combination thereof. Preferably, greater than 80% of all trapped analytes are directly delivered to the analytical instrument.

Another embodiment provides a method of trapping a sample for trace analysis, wherein the method comprises placing an adsorbent material in a trap sample concentrator, wherein the trap sample concentrator comprises a pair of opposed ends each having an opening; a trap region in between the pair of opposed ends and having a longitudinal axis; a pair of side portions that are substantially parallel to the longitudinal axis; a plurality of ports in the pair of side portions; and a plurality of stops adapted to open and close the plurality of ports and the openings of the pair of opposed ends. The method further comprises opening the plurality of ports in the pair of side portions by removing the polarity stops; closing the openings in the pair of opposed ends using the plurality of stops; loading the trap region with trace analytes flow; closing the plurality of ports in the pair of side portions using the plurality of stops; opening the openings in the pair of opposed ends by removing the plurality of stops; introducing an elution buffer in the trap region; and passing trapped analytes from the trap region to a connected analytical instrument.

Additionally, the method may further comprise configuring the trap region with exactly two side portions each positioned on directly opposite sides of one another. Preferably, the plurality of ports of a first side portion are configured as loading inlet ports, the plurality of ports of a second side portion are configured as loading outlet ports, a first end of the pair of opposed ends is configured as an eluting inlet port, and a second end of the pair of opposed ends is configured as an eluting outlet port. The method may further comprise configuring the trap region in any of a straight, U-shape, and coil configuration.

Preferably, the plurality of ports are adapted to create a greater flow rate of materials passing through than the flow rate created by the openings in pair of opposed ends. Furthermore, the plurality of ports are preferably adapted to pass through an ultra-trace sample of interest through the trap region during a loading stage of a trap sample process, and the openings in the pair of opposed ends are preferably adapted to pass through an elution buffer media through the trap region during an eluting stage of the trap sample process. Also, a second end of the pair of opposed ends is preferably adapted to connect to the analytical instrument comprising any of a liquid chromatograph, gas chromatograph, mass spectrometer, ultraviolet/visible light detector, an IR, and a combination thereof, wherein preferably greater than 80% of all trapped analytes are directly delivered to the analytical instrument.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIGS. 1 and 2 illustrate schematic diagrams of a conventional trap sample concentrator;

FIG. 3 illustrates a schematic diagram of a trap sample concentrator during a loading stage in a straight tube configuration according to an embodiment herein;

FIG. 4 illustrates a schematic diagram of a trap sample concentrator during an elution stage in a straight tube configuration according to an embodiment herein;

FIG. 5(A) illustrates a top view of a trap sample concentrator in a U-tube configuration according to an embodiment herein;

FIG. 5(B) illustrates a perspective view of the boxed section of FIG. 5(A) according to an embodiment herein;

FIG. 5(C) illustrates a block diagram of a system according to an embodiment herein;

FIGS. 6 and 7 are graphical representations illustrating results achieved by the embodiments herein; and

FIG. 8 is a flow diagram illustrating a preferred method according to an embodiment herein.

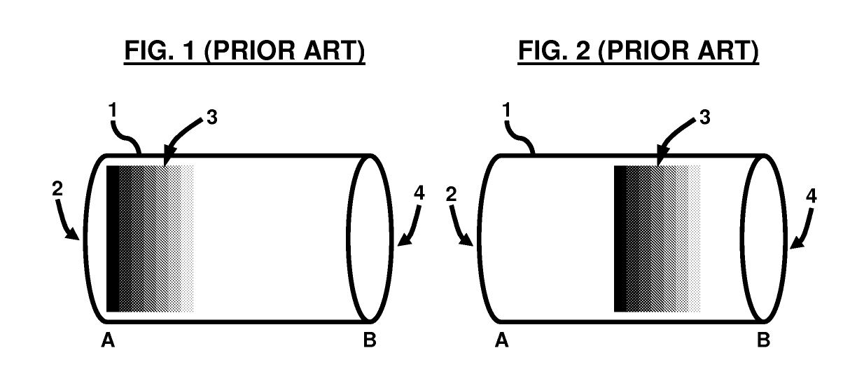

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

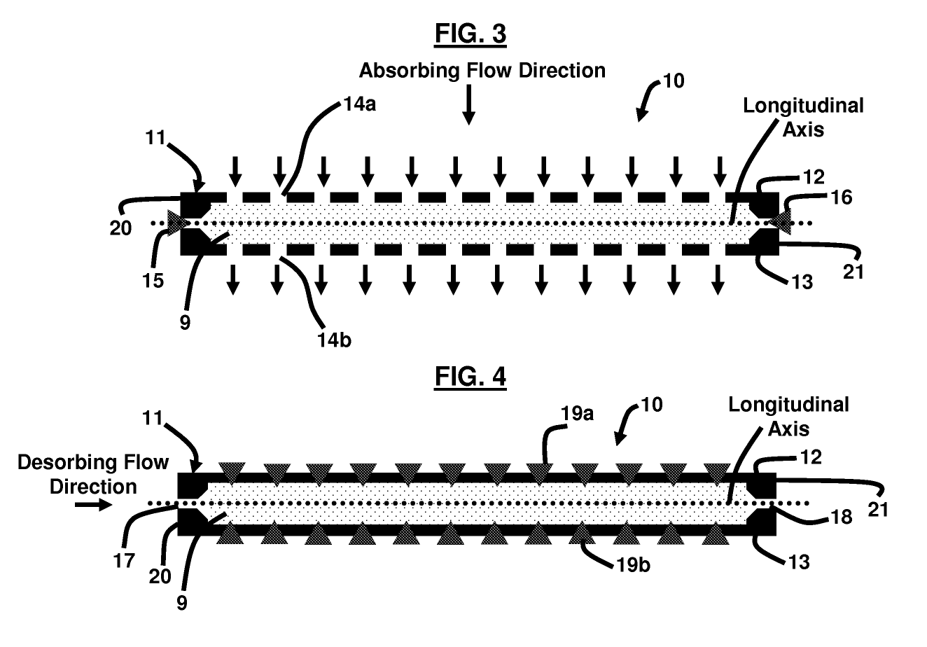

As mentioned, there remains a need for a trap capable of reducing the overall trapping time or dramatically reducing the time of concentrating trace analytes or even concentrating ultra-trace analytes. The embodiments herein achieve this by providing a trap that decreases the loading and elution stage for trapping samples. Referring now to the drawings, and more particularly to FIGS. 3 through 8, where similar reference characters denote corresponding features consistently throughout the figures, there are shown preferred embodiments.

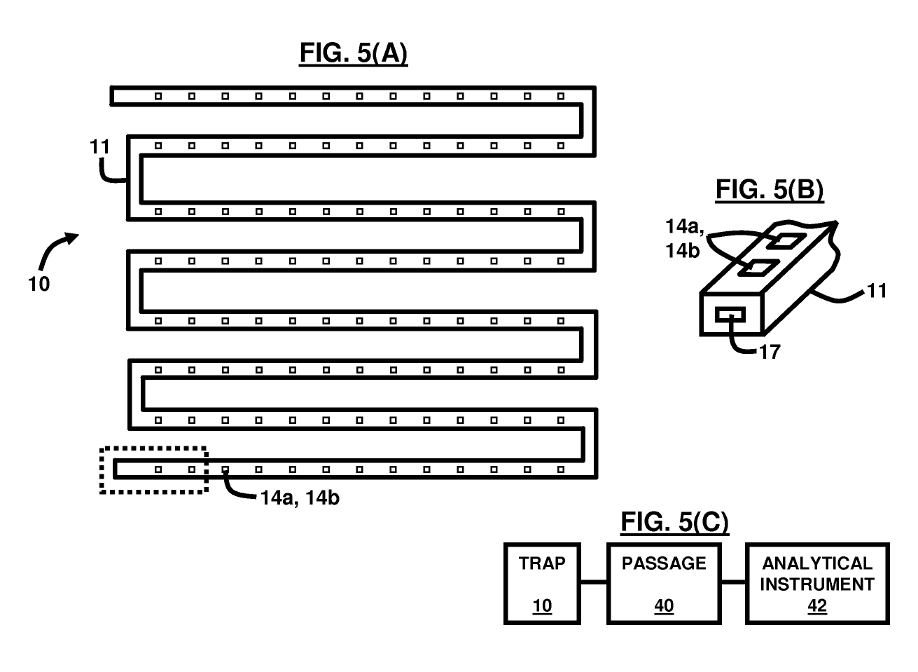

FIGS. 3 and 4 illustrate a trap sample concentrator 10 according to an embodiment herein. The trap 10 shown in FIGS. 3 and 4 is depicted as having a straight tube configuration, however the trap 10 may also be U-shaped (FIGS. 5(A) and 5(B)), coiled, or other shape. The trap sample concentrator 10 comprises a tube 11 ranging in length preferably, for example, from approximately 1 cm to 30 cm and having an inside diameter preferably, for example, in the range of between approximately 0.050 mm and 2 cm. The inner diameter of the tube 11 may be of such a size that desorption flow rates yield an average linear velocity of approximately 0.1-30 cm/min. Moreover, the length of the tube 11 may be dimensioned and configured at such a length that adsorption (loading) flow rates yield an average linear velocity of approximately 0.1-30 cm/min. The cross-sectional area of the trap 10 can be circular, square, rectangular, or any other shape. The tube 11 may be constructed of any alloy or inert material, and preferably stainless steel. The trap sample concentrator 10 includes at least one sorbent material 9 which is adapted to retain or trap trace chemicals of interest (analytes) in gas or in liquid during the rapid loading flow stage.

Different combinations and/or ratios of sorbents 9 may be utilized depending on the application or method being used and the analytes being studied. The sorbent materials 9 may comprise any of silica gel, coconut charcoal (activated charcoal), activated alumina, Carbopack™ B materials, Carbopack™ C materials, Carbopack™ F materials, Carbosieve™ S-111 materials, Carboxen™ 1000 materials, Carboxen™ 1001 materials, Carbowax™ 20M materials, Tenax® TA materials, SP-2100/Chromosorb® W AW, SP-2250, SP-1200, and SP-1000 materials, Porapak® Series (N, P, PS, Q, QS, R, S, T) polymers, Porasil® gels, Porasil® B gels, HayeSep® Series (A, B, C, D, N, P, Q, R, S) polymers, Durapack® n-Octane/Porasil C materials, Molecular Sieve 5A, Molecular Sieve 13X, Molecular Sieve 4A, and 2,6-diphenylene oxide polymer.

The trap sample concentrator 10 provides a quick means for concentrating ultra-trace sample (analytes) in gas or liquid phase and delivering the same to an analytical instrument 42 (shown in FIG. 5(C)). The embodiments herein create a preferably perpendicular (or near perpendicular) flow of sample loading (trapping or absorbing) to the desorbing (release) flow direction. One embodiment includes a straight tube 11 with linear-perforated side-holes 14a, 14b (holes 14a, 14b are perpendicular to the central longitudinal axis of the tube 11) on opposite sides 12, 13, respectively, of the tube 11 as shown in FIG. 3. The perpendicular perforated holes 14a, 14b are then closed using stops 19 as shown in FIG. 4 and elution flow ports (holes) 17, 18 are opened to prepare for eluting the adsorbed/trapped trace sample (through the tube central axis).

All trapped analytes are directly delivered to an analytical instrument 42 (shown in FIG. 5(C)) by the much smaller eluting/desorption flow rate. At least one sorbent 9 is included in the tube 11, however as many sorbents 9 as desired, e.g., six or seven, etc. different sorbents 9, may be included. During the loading process of FIG. 3, stops 15, 16 are placed in the elution flow ports 17, 18 (best shown in FIG. 4), respectively. Conversely, during the eluting process of FIG. 4, stops 19a, 19b are placed in the side holes 14a, 14b. Delivery of the trapped analytes to the analytical instrument 42 is achieved by passing the trapped analytes through a passage 40 being selectively connectable between the trap 10 and the analytical instrument 42 as illustrated in the system block diagram of FIG. 5(C).

For volatile analytes, the volatile analytes of interest are in a gas phase. For volatile analytes in liquid or solid, an aliquot of the sample is introduced into a glass container. In most cases, a 5 mL sample volume provides adequate sensitivity, but when more sensitivity is required, a 25 mL volume (or more) may be used to achieve the minimum detection limits (MDLs) specified in some methods. The sample is purged with either ultra-pure helium or nitrogen (greater than 99.998%) at a specified flow rate, temperature, and time. This extracts the volatile analytes from the sample matrix (liquid or solid) and transfers the volatile analytes into the gas phase and into the loading ports 14a. The volatile analytes in the gas phase are introduced into an ambient temperature trap (i.e., typically, a short, ⅛-inch outer diameter packed column) comprising as few as one to as many as four different adsorbents.

Following the purging and trapping step (loading step as in FIG. 3), the volatile analytes are thermally desorbed (or, injected) onto an analytical instrument 42 (of FIG. 5(C)) such as a gas chromatographic (GC) column. This is accomplished by rapidly heating the helium-swept trap 10 to a sufficient temperature to transfer the analytes in a narrow injection band (eluting stage as in FIG. 3) (in an attempt to simulate the effect of a direct syringe injection). The chromatographic separation employing columns designed specifically for the analysis then begins. The most commonly used detectors are mass spectrometers (MS) or photoionization detectors (PID) coupled in series with electrolytic conductivity detectors (ELCD). The final step in the analysis is the preparation of the trap sample concentrator 10 for the next sample. This involves baking the trap sample concentrator 10 at an elevated temperature (for example, greater than 100° C.) with a flow through the trap 10 in the reverse direction of the purge/extraction flow. The baking step and the chromatographic separation are, for the most part, carried out simultaneously.

For non-volatile analytes, the non-volatile analytes of interest are in a liquid phase. For volatile analytes in a non-liquid matrix (cell, soil, etc.), an aliquot of the sample is introduced into a glass container. In most cases, a 5 mg sample provides adequate sensitivity, but when more sensitivity is required, a 25 mg (or more) may be needed to achieve the MDLs specified in some methods. The sample is suspended in the desired liquid and vigorously shaken (vortex, sonication, etc.) to extract and dissolve non-volatile or low-volatile analytes onto the liquid loading buffer at a specified flow rate, temperature, and time. This extracts the volatile analytes from the sample matrix (liquid or solid) and transfers the volatile analytes into a desired liquid loading buffer. The non-volatile or low-volatile analytes in liquid loading buffer is introduced into an ambient temperature liquid-trap 10, (i.e., typically, a short, ¼-inch outer diameter packed column) comprising as few as one to as many as four different adsorbents.

Following the trapping (loading) step (FIG. 3), the non-volatile or low-volatile analytes are desorbed (or, injected, FIG. 4) onto an analytical instrument 42 (shown in FIG. 5(C)) such as a LC column. This is accomplished by replacing the loading liquid buffer (typically aqueous) with an elution liquid buffer (typically, organic) and then the trap 10 is swept to transfer the analytes into a narrow injection band at the smallest volume (in an attempt to simulate the effect of a sample loop injection). The chromatographic separation employing columns designed specifically for the analysis then begins. The most commonly used detectors are MS or ultra-violet/visible light detector (UV/Vis), or florescent induced detector (FID). The final step in the analysis is the preparation of the sample concentrator 10 for the next sample. This involves passing a high concentration of elution buffer (organic) through the trap 10 followed by conditioning with the loading buffer only (no analytes). The preparation step and the chromatographic separation are, for the most part, carried out simultaneously.

The following example illustrates the performance of the trap sample concentrator 10 by showing the role of the number of side holes 14a, 14b on reducing loading time and improving the overall performance of the trap 10. In this example, a square cross-sectional shape (for example, as shown in FIG. 5(B)) is used instead of a standard tube (circular cross-sectional area) for simplicity in representing the equations. The cross-sectional area of the square is x² (x in cm). The optimum linear velocity across the sorbent material 9 is taken as 6 cm/min. Then, the optimum elution flow rate across the square trap 10 is 6x² (cc/min). If the square trap 10 has a length of L (L in cm), then the elution time (in minutes) required for the trapped samples to desorb and reach the outlet port 18 is (Lx²)/(6x²). Also, the optimum loading flow rate is 6Lx (cc/min). The loading time (in minutes) required to trap a large sample volume of size V (in mL) is V/(6Lx). The total time required to load the desired large sample volume (V) and elute trapped analytes out is (V/(6Lx)+(Lx²)/(6x²)=V/(6Lx)+L/6). To find the minimum total time needed to load a sample of volume V, the length of the trap (L) is varied until a minimum total time value is found. Another way to find the minimum total time is by taking the first derivative (dt/dL) of this function (V/(6Lx)+L/6) with respect to L. Then, the minimum total time equals (⅓)(V/x)^{1/2} and is not a function of L.

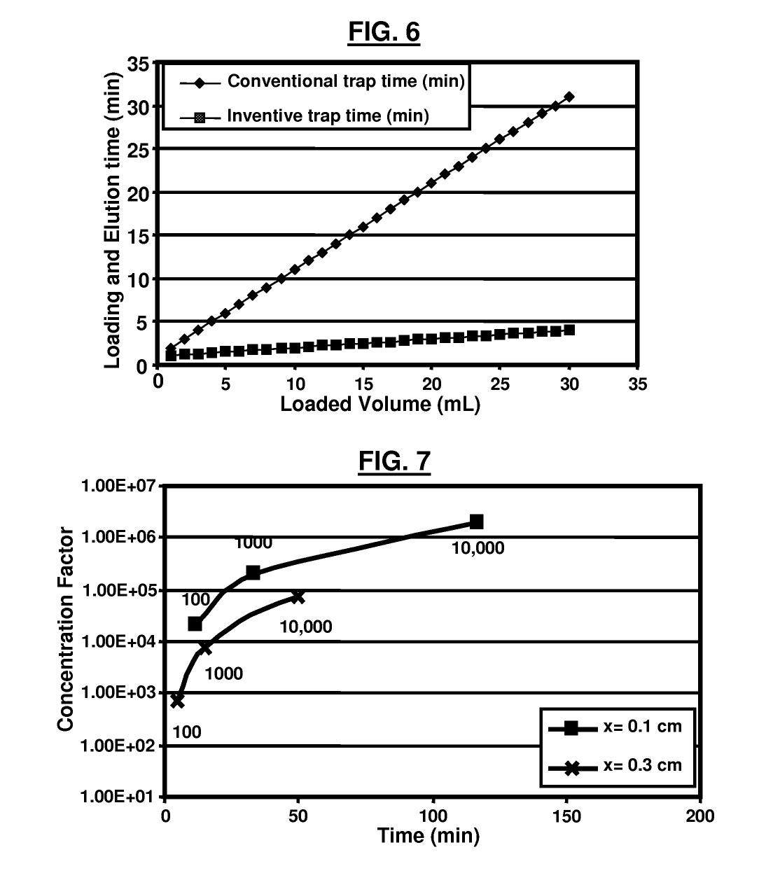

FIG. 6 illustrates the difference in the loading and elution time using the conventional trap 1 and the trap 10 provided by the embodiments herein. As FIG. 6 indicates, the trap 10 provided by the embodiments herein offers a significantly lower loading and elution-time than the conventional trap 1. FIG. 7 illustrates two curves for the trap 10 with a square size of x=0.1 cm and x=0.3 cm, respectively. The x-axis represents the minimum total time required to load and elute a sample volume of 100 mL, 1000 mL, and 10000 mL. The y-axis represents the concentration factor (the ratio of the loaded volume to the eluted volume=V/(3x³)). Normally, the desorbed sample eluted in a volume is approximately 3x³ (mL). The concentration factor increases as a quadratic function with respect to the optimum total time at a fixed square size (x). The concentration factor equals three times the total time squared/x².

The embodiments herein provide a trap sample concentrator 10 that is adapted to enhance the performance at low adsorption flow rates and reduce the loading time of conventional traps 1 significantly. The embodiments herein use flow paths schemes that are unique to optimize the adsorption performance at such flows and produce significantly reduced loading times (adsorption). New flow path schemes can be used in any shape starting from a narrow bore capillary tube (FIGS. 3 and 4), U-tube configuration (FIG. 5(A), to flat discs (not shown). This allows for a faster sampling processing time while maintaining high trapping efficiency as well as elution of analytes in the smallest eluant band needed for analytical detection systems or purification processes. Additionally, the trap sample concentrator 10 provided by the embodiments herein can also be used for purification scenarios.

The embodiments herein are applicable to a variety of applications from large scale all the way down to micro or nano scales. By choosing the proper sorbent 9 and designing the flow path schemes during the loading and elution stage at optimum flow rates, the embodiments herein are capable of introducing the needed concentrated sample to the head of the column (GC and/or LC) in a tightly focused band during the desorbing step. Quickly trapping the largest amount of trace sample or ultra-trace sample from a large sample volume and transferring the entire trapped sample to the GC or LC column significantly improves the detection limits. The estimated typical detection limits using the embodiments herein are in the parts per quadrillion or less (taking average detectors having detection limits in the parts per million). The ultra-trace analytes are drawn (extracted) from a sample derived from any of water, soil, food, beverage, pharmaceutical products, biological samples, forensic samples, air samples, gaseous samples, polymers, and sediment matrices.

In general, in one aspect, the embodiments herein provide a sample concentrator 10, which is useful for concentrating ultra-trace samples for delivery to an analytical instrument 42. The sample concentrator 10 includes a tube 11 comprising at least one sorbent material 9 which retains or traps analytes; where greater than 90% of all trapped analytes are directly delivered to an analytical instrument 42 at an optimum desorption (elution) flow rate, without splitting or back flushing.

The embodiments herein offer significant benefits compared to the conventional standard traps 1. The trapping capacity, performance, and speed of the trap 10 are maximized compared to conventional traps 1 for ultra-trace sample concentrations. The smaller size and lower mass of a conventional trap 1 has an inherent problem of a long loading time, while the embodiments herein significantly reduces the long loading time while preserving the good characteristics of a small size, and lower mass and low flow rates of the conventional trap 1. The increases of sample loading volumes in a small fraction of a time afforded by the embodiments herein improves analysis, increases the sensitivity, and greatly reduces purification time. Furthermore, the embodiments herein can be used with variety of detection systems, thereby decreasing run times without sacrificing resolution. Generally, the embodiments herein dramatically increases the loading (adsorption) flow rates while maintaining the optimum linear velocity across the sorbent material 9.

The trap 10 provided by the embodiments herein is adapted to operate at higher loading flow rates and trap ultra-trace chemicals from large volumes. The loading time is kept at a minimum and much less than conventional traps 1. Accordingly, the embodiments herein address the need for sampling a large volume of trace or ultra-trace chemicals and matching the optimum flow requirements for the trap 10 and the analytical column 42. The trap 10 provided by the embodiments herein has a preferred perpendicular flow scheme between the loading and eluting flow direction. This new perpendicular flow scheme allows for fast loading of large volume of ultra-trace sample, while a smaller inner diameter (smaller cross-sectional area) allows for an efficient desorption at lower flow rates during elution. The trap 10 concentrates ultra-trace bio-samples by more than 100,000 fold for same time as current commercial traps 1.

Generally, the embodiments herein (1) allow the use of large sample volumes while increasing sensitivity of the method; (2) maintain adequate (optimum) linear velocity through the sorbent material 9 of the trap 10 at high flow rates during loading and low flow rates during elution; (3) reduce the amount of sorbent 9 required to fill the trap 10; (4) decrease or eliminate the biased exposure of sorbent material 9 inherent in conventional traps 1 during loading, and (5) reduce surface area and carryover.

Furthermore, the embodiments herein provide an exceptional improvement in the performance of conventional traps 1 due to: (a) lower detection limits by increasing the trace sample volume; and (b) elimination of biased exposure of the trace sample to the sorbent material 9. The efficient absorption at high flow rates and large volumes followed by desorption at lower flow rates allows the trap sample concentrator 10 provided by the embodiments herein to be coupled to variety of detection systems 42 with varying sensitivity. Since the desorption rate can be reduced to any flow while maintaining the large volume loading of trace sample, the entire sample can be analyzed by the GC-MS detection system or LC-MS system without splitting off or losing part of the sample as compared to the conventional traps 1 or changing column.

The implementation of the embodiments herein for conventional 1 minute loading, 100 mL (instead of conventional 1 mL) of sample is passed through the trap 10 and retained. The maximum amount of sample that can be eluted out and analyzed by the GC-MS or LC-MS is approximately equivalent to the amount in the 100 mL of sample loaded and trapped by the trap 10. Therefore, within the context of the embodiments herein the minimum detection limit has been improved and lowered by a factor of approximately 100 compared with the conventional taps 1. Increasing the length of the trap 10 increases the sample volume that can be loaded in 1 minute. For example, if the length of the trap 10 is doubled, the sample volume that can be loaded in 1 minute is 200 mL. This is especially significant in the analysis of drinking water samples, which are much lower in organic content than other samples. Thus, analytes that are lower in concentration are detected with greater sensitivity with the embodiments herein with little time. This is also especially significant in the analysis of protein samples, which are much lower in concentration than other chemicals. Thus, analytes that are lower in concentration are detected with greater sensitivity with the embodiments herein.

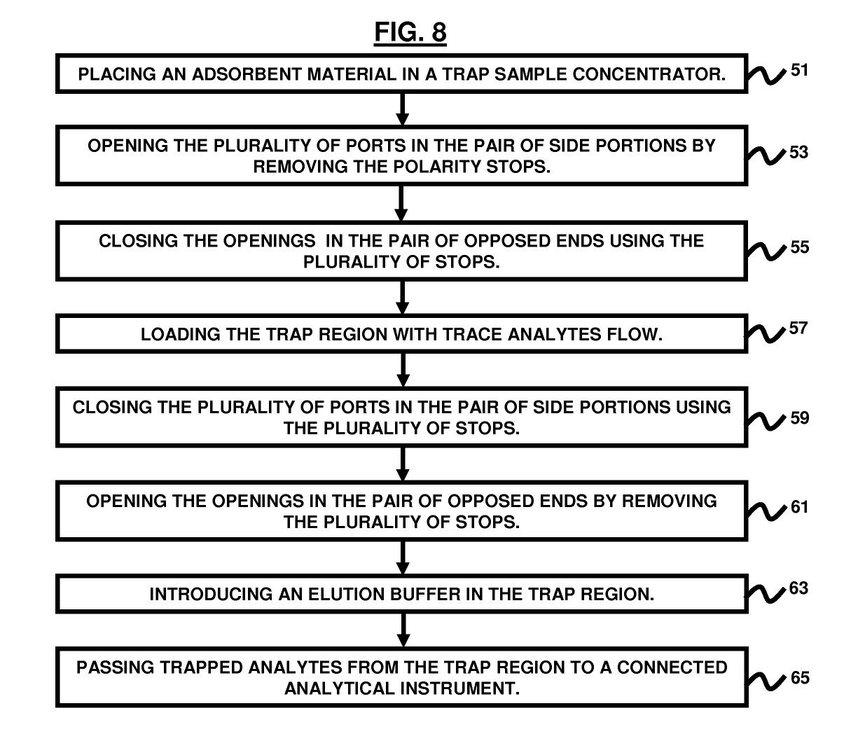

FIG. 8, with reference to FIGS. 3 through 7, is a flow diagram illustrating a method of trapping a sample for trace analysis according to an embodiment herein, wherein the method comprises placing (51) an adsorbent material 9 in a trap sample concentrator 10, wherein the trap sample concentrator 10 comprises a pair of opposed ends 20, 21 each having an opening 17, 18; a trap region 11 in between the pair of opposed ends 20, 21 and having a longitudinal axis; a pair of side portions 12, 13 that are substantially parallel to the longitudinal axis; a plurality of ports 14a, 14b in the pair of side portions 12, 13; and a plurality of stops 19a, 19b, 15, 16 adapted to open and close the plurality of ports 14a, 14b and the openings 17, 18 of the pair of opposed ends 20, 21. The method further comprises opening (53) the plurality of ports 14a, 14b in the pair of side portions 12, 13 by removing the polarity stops 19a, 19b; closing (55) the openings 17, 18 in the pair of opposed ends 20, 21 using the plurality of stops 15, 16; loading (57) the trap region 11 with trace analytes flow; closing (59) the plurality of ports 14a, 14b in the pair of side portions 12, 13 using the plurality of stops 19a, 19b; opening (61) the openings 17, 18 in the pair of opposed ends 20, 21 by removing the plurality of stops 15, 16; introducing (63) an elution buffer in the trap region 11; and passing (65) trapped analytes from the trap region 11 to a connected analytical instrument.

Additionally, the method may further comprise configuring the trap region 11 with exactly two side portions 12, 13 each positioned on directly opposite sides of one another. Preferably, the plurality of ports 14a of a first side portion 12 are configured as loading inlet ports, the plurality of ports 14b of a second side portion 13 are configured as loading outlet ports, a first end 20 of the pair of opposed ends 20, 21 is configured as an eluting inlet port, and a second end 21 of the pair of opposed ends 20, 21 is configured as an eluting outlet port. The method may further comprise configuring the trap region 11 in any of a straight, U-shape, and coil configuration. Preferably, the plurality of ports 14a, 14b are adapted to create a greater flow rate of materials passing through than the flow rate created by the openings 17, 18 in pair of opposed ends 20, 21.

Furthermore, the plurality of ports 14a, 14b are preferably adapted to pass through an ultra-trace sample of interest through the trap region 11 during a loading stage of a trap sample process, and the openings 17, 18 in the pair of opposed ends 20, 21 are preferably adapted to pass through an elution buffer media through the trap region 11 during an eluting stage of the trap sample process. Also, a second end 21 of the pair of opposed ends 20, 21 is preferably adapted to connect to the analytical instrument comprising any of a liquid chromatograph, gas chromatograph, mass spectrometer, ultraviolet/visible light detector, an IR, and a combination thereof, wherein preferably greater than 80% of all trapped analytes are directly delivered to the analytical instrument.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A trap sample concentrator comprising:
a trap region having a longitudinal axis, said trap region comprising:
a first end having an opening;
a second end having an opening, said back end being positioned opposite to said first end;
a first side portion that is substantially parallel to said longitudinal axis, said first side portion comprising a plurality of ports;
a second side portion that is substantially parallel to said longitudinal axis, said second side portion comprising a plurality of ports; and
a channel region positioned in between and bounded by said first end, said second end, said first side portion, and said second side portion; and
at least one stop adapted to open and close said plurality of ports and the openings of said first end and said second end.

2. The trap sample concentrator of claim 1, wherein said channel region is adapted to house at least one type of adsorbent material, wherein trace analytes become trapped upon the introduction of a loading buffer in said channel region.

3. The trap sample concentrator of claim 1, wherein said trap region comprises exactly two side portions each positioned on directly opposite sides of said channel region.

4. The trap sample concentrator of claim 1, wherein said plurality of ports located in said first side portion comprise loading inlet ports, wherein said plurality of ports located in said second side portion comprise loading outlet ports, wherein said first end is an eluting inlet port, and wherein said second end is an eluting outlet port.

5. The trap sample concentrator of claim 1, wherein said at least one stop is adapted to close said first end and said second end while said plurality of ports are open, and wherein said plurality of ports are adapted to close while said first end and said second end are open.

6. The trap sample concentrator of claim 1, wherein said trap region is dimensioned and configured in any of a straight, U-shape, and coil configuration.

7. The trap sample concentrator of claim 1, wherein said plurality of ports are adapted to create a greater flow rate of materials passing through than the flow rate created by said openings in said first end and said second end.

8. The trap sample concentrator of claim 1, wherein said plurality of ports are adapted to pass through a trace sample of interest through said channel region during a loading stage of a trap sample process, and wherein said openings in said first end and said second end are adapted to pass through an elution buffer media through said channel region during an eluting stage of said trap sample process.

9. The trap sample concentrator of claim 2, wherein said second end is adapted to connect to an analytical instrument comprising any of a liquid chromatograph, gas chromatograph, mass spectrometer, ultraviolet/visible light detector, an infrared (IR) detector, and a combination thereof.

10. The trap sample concentrator of claim 9, wherein greater than 80% of all trapped analytes are directly delivered to said analytical instrument.

11. A trap sample concentrator comprising:
a pair of opposed ends each having an opening;
a trap region in between said pair of opposed ends and having a longitudinal axis;
a pair of side portions comprising a plurality of ports that are adapted to facilitate a flow of materials therethrough in a direction that is substantially perpendicular to said longitudinal axis;
a plurality of ports in said pair of side portions; and
a plurality of stops adapted to open and close said plurality of ports in said pair of side portions and the openings of said pair of opposed ends.

12. The trap sample concentrator of claim 11, wherein said trap region is adapted to house at least one type of adsorbent material, wherein trace analytes become trapped upon the introduction of a loading buffer in said trap region.

13. The trap sample concentrator of claim 11, wherein said trap region comprises exactly two side portions each positioned on directly opposite sides of one another.

14. The trap sample concentrator of claim 11, wherein said plurality of ports of a first side portion are loading inlet ports, wherein said plurality of ports of a second side portion are loading outlet ports, wherein a first end of said pair of opposed ends is an eluting inlet port, and wherein a second end of said pair of opposed ends is an eluting outlet port.

15. The trap sample concentrator of claim 11, wherein said plurality of stops are adapted to close said pair of opposed ends while said plurality of ports are open, and wherein said plurality of stops are adapted to close said plurality of ports while said pair of opposed ends are open.

16. The trap sample concentrator of claim 11, wherein said trap region is dimensioned and configured in any of a straight, U-shape, and coil configuration.

17. The trap sample concentrator of claim 11, wherein said plurality of ports are adapted to create a greater flow rate of materials passing through than the flow rate created by the openings in pair of opposed ends.

18. The trap sample concentrator of claim 11, wherein said plurality of ports are adapted to pass through a trace sample of interest through said trap region during a loading stage of a trap sample process, and wherein the openings in said pair of opposed ends are adapted to pass through an elution buffer media through said trap region during an eluting stage of said trap sample process.

19. The trap sample concentrator of claim 12, wherein a second end of said pair of opposed ends is adapted to connect to an analytical instrument comprising any of a liquid chromatograph, gas chromatograph, mass spectrometer, ultraviolet/visible light detector, an infrared (IR) detector, and a combination thereof.

20. The trap sample concentrator of claim 19, wherein greater than 80% of all trapped analytes are directly delivered to said analytical instrument.

21. A method of trapping a sample for trace analysis, said method comprising:
placing an adsorbent material in a trap sample concentrator, wherein said trap sample concentrator comprises:
a pair of opposed ends each having an opening;
a trap region in between said pair of opposed ends and having a longitudinal axis;
a pair of side portions that are substantially parallel to said longitudinal axis;
a plurality of ports in said pair of side portions; and
a plurality of stops adapted to open and close said plurality of ports and the openings of said pair of opposed ends;
opening said plurality of ports in said pair of side portions by removing said polarity stops;
closing the openings in said pair of opposed ends using said plurality of stops;
loading said trap region with trace analytes flow;
closing said plurality of ports in said pair of side portions using said plurality of stops;
opening said openings in said pair of opposed ends by removing said plurality of stops;
introducing an elution buffer in said trap region; and
passing trapped analytes from said trap region to a connected analytical instrument.

22. The method of claim 21, further comprising configuring said trap region with exactly two side portions each positioned on directly opposite sides of one another.

23. The method of claim 21, wherein said plurality of ports of a first side portion are configured as loading inlet ports, wherein said plurality of ports of a second side portion are configured as loading outlet ports, wherein a first end of said pair of opposed ends is configured as an eluting inlet port, and wherein a second end of said pair of opposed ends is configured as an eluting outlet port.

24. The method of claim 21, further comprising configuring said trap region in any of a straight, U-shape, and coil configuration.

25. The method of claim 21, wherein said plurality of ports are adapted to create a greater flow rate of materials passing through than the flow rate created by the openings in pair of opposed ends.

26. The method of claim 21, wherein said plurality of ports are adapted to pass through an ultra-trace sample of interest through said trap region during a loading stage of a trap sample process, and wherein the openings in said pair of opposed ends are adapted to pass through an elution buffer media through said trap region during an eluting stage of said trap sample process.

27. The method of claim 22, wherein a second end of said pair of opposed ends is adapted to connect to said analytical instrument comprising any of a liquid chromatograph, gas chromatograph, mass spectrometer, ultraviolet/visible light detector, an infrared (IR) detector, and a combination thereof.

28. The trap sample concentrator of claim 27, wherein greater than 80% of all trapped analytes are directly delivered to said analytical instrument.
